(19) United States
(12) Patent Application Publication
(10) Pub. No.: US 2011/0083128 A1
(43) Pub. Date: Apr. 7, 2011

(54) METHOD FOR SELECTING SOFTWARE AND INSTALLING SAME VIA A TELEMATIC MODULE IN A MOTOR VEHICLE

(75) Inventors: Nathan Hoch, Fort Wayne, IN (US); Andrew Smith, Cedar Rapids, IA (US)

(73) Assignee: International Truck Intellectual Property Company, LLC, Warrenville, IL (US)

(21) Appl. No.: 12/572,472

(22) Filed: Oct. 2, 2009

(51) Int. Cl. G06F 9/445

(52) U.S. Cl. 717/174

(57) ABSTRACT

Methods for configuring a telematic module and/or a non-telematic module in a motor vehicle.

### FIELD OF THE DISCLOSURE

This disclosure relates to data systems in motor vehicles that include telematic modules.

### BACKGROUND OF THE DISCLOSURE

A vehicle telematic system typically comprises a telematic module that embodies wireless technology and GPS tracking technology that collectively enable data to be exchanged between the vehicle and a location remote from the vehicle. For example, data related to operation of multiple vehicles in a fleet can be automatically reported from each vehicle to a facility that monitors the fleet for various purposes such as vehicle diagnostics or tracking deliveries.

A telematic module may also interface with one or more other electronic modules in a vehicle such as a body controller module, an engine controller module, a transmission controller module, or an instrument cluster and display module.

Truck and bus fleet managers may have different truck and bus brands and models in which they wish to install telematic modules, and/or in which telematic modules are already installed. The installation process comprises configuring each module to a specific vehicle so as to take into account specific vehicle features and specific information that is to be exchanged between the telematic module and a facility that monitors vehicles in a fleet.

Software in a telematic module already installed in a vehicle may be updated from time to time for various reasons, such as to allow exchange of information that wasn't previously exchanged or for patching installed software.

Several modalities exist for installing or updating software in a telematic module. They include use of a service tool that can be connected to a data bus in a vehicle, a USB drive connected to the module, and via wireless from a host site. On-site procedures can be labor- and time-intensive, especially if a technician must extract information about a particular vehicle and its telematic module via a service tool before new or updated software can be installed.

Any installation or update should be accomplished with accuracy and efficiency, but limitations that interfere with those objectives may be present. Human error, limitations on bandwidth and hardware, and differences in vehicle features in a fleet of vehicles are examples.

In a large vehicle fleet, different vehicles may have different hardware, software, and/or customer-specific customizations. The identification of which vehicles have which hardware, software, or other features can complicate an installation or update process, and if due care is not exercised, errors may occur during the process.

### SUMMARY OF THE DISCLOSURE

The present disclosure describes a process in which correct software is selected for a particular telematic module in a particular vehicle so as to enable it to be configured or re-configured by various modalities such as the ones mentioned above. After the software has been loaded into the module, the module autonomously configures or re-configures itself. Once that has been completed, the module is used as a gateway for programming or updating other modules in the vehicle.

The steps of configuring or re-configuring the telematic module comprise reception of a software package by the module without interruption of current operation of the module, validation of the package (does this mean validation of receipt of the package or validation of the contents of the package or both??), installation of the package, re-start or re-boot of the module, data and configuration migration, component execution verification, and clean-up (what is “clean-up”??).

Each of these steps is to be verified for successful completion before the next step is allowed to proceed. Non-verification of successful completion of a step results in a controlled process for terminating an on-going installation or update.

After the telematic module has been successfully configured or re-configured, it can function as a gateway for the installation or updating of software in a non-telematic module in the vehicle, such as the modules mentioned earlier.

The steps comprise reception of a software package for the non-telematic module by the telematic module without interruption of the telematic module's current operation, validation of the package (same questions as posed above), relaying the package to the non-telematic module without interrupting operation of the telematic module, and then installing the relayed packing using a step-by-step verification process as similar to the one for configuring or re-configuring the telematic module.

A particular software package may be released in some identifiable way such as by a release or version number. Versions of a package that have been released as successive updates can be stored in a suitable repository for enabling a proper version to be installed in a particular vehicle as either a new or an updated feature. For accomplishing this, a database of information about each of a number of vehicles is compiled. The data base identifies specific hardware features present in each vehicle, such as specific modules, accessories, options, etc. It also identifies specific software in the vehicle, such as in the telematic module and other non-telematic modules, including identification of the particular version of any installed software.

When software is to be installed in a vehicle, either in conjunction with installation of new equipment or to update existing software, the data base can be examined for various versions suitable for the hardware/software present in the vehicle. Once a suitable version has been identified, it can be installed by any of the modalities mentioned earlier.

Even if the hardware/software configuration of a vehicle in which software is to be installed is not an exact match to that of a vehicle already in the data base, identification of a close match and use of corresponding software may be suitable as is or at least close enough to be adapted for the vehicle.

One general aspect of the disclosure relates to a method for installing or updating software in a motor vehicle having an electronic data system that includes a telematic module.

The method comprises while the telematic module is operating, loading a software package into the module, then validating the package, then installing the package in the module, then stopping and re-starting the module to cause the package to become operational, causing pre-existing data and configuration information to migrate for use by the now-operational package, and operating the package with the migrated data and configuration information to verify proper operation.

A further aspect relates to use of the telematic module as a gateway for installing software or updating existing software in a non-telematic module in the vehicle.

Another aspect relates to a method for installing or updating software in a motor vehicle having an electronic data system and equipment that includes a telematic module.

The method comprises comparing certain data about the electronic system and equipment in the vehicle with corresponding data about similar vehicles already in a data base to identify software suitable for installation in the vehicle, and installing the identified software in the vehicle via the telematic module.

The foregoing summary, accompanied by further detail of the disclosure, will be presented in the Detailed Description below with reference to the following drawings that are part of this disclosure.

### BRIEF DESCRIPTION OF THE DRAWINGS

FIG. 1 is a schematic diagram relating generally to vehicle telematics.

FIG. 2 is a schematic diagram disclosing modalities for communicating with the vehicle telematics.

FIG. 3 is a schematic diagram relating to a method for installing/updating software in the telematics.

FIG. 4 is schematic diagram relating to a method for installing/updating software in the non-telematic modules via telematics.

### DETAILED DESCRIPTION

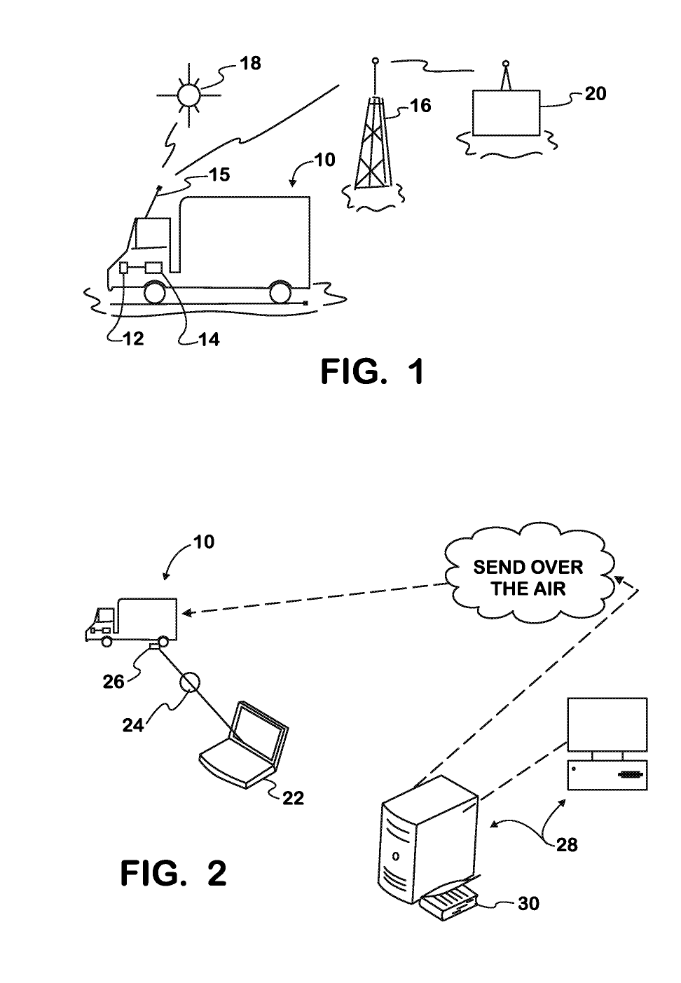

FIG. 1 shows a mobile vehicle 10, a truck for example, having an electronic data system 12. Data system 12 comprises data busses via which various devices and modules in vehicle 10 communicate for control and informational purposes.

A telematic module 14 is installed in vehicle 10 in association with data system 12. When installed, module 14 can wirelessly communicate through an antenna system 15 bi-directionally with a tower 16 in a cellular communications system and with one or more satellites 18 of the Global Positioning System. The cellular communications system provides bi-directional communication with a land-based station 20 remote from vehicle 10 to complete the transmission path between the station and the vehicle. Module 14 can also communicate with other devices and modules in data system 12.

FIG. 2 shows a portable laptop computer 22 connected via a cable 24 with a diagnostic connector 26 in vehicle 10, as one modality for installing or updating software in module 14. The Figure also shows a wireless modality comprising a website 28 having a data base 30. Wireless communication between vehicle 10 and website 28 occurs via cellular communication as in FIG. 1.

Website 28 collects vehicle-specific information about various vehicles for entry and compilation in data base 30. The vehicle-specific information may be include VIN number, vehicle make, vehicle model, vehicle equipment, and/or installed software in the vehicle. What this does is to enable a vehicle not already in the database to possibly be correlated with similar vehicles already in the data base.

For example, a VIN number contains some information about the make, year and model of the vehicle. Vehicles having certain similarities in VIN numbers may have similar or even identical electronic data systems, and thereby enable a module in a vehicle not in the database to be configured using configuration data from a similar one already in the data base. Even if the configuration is not perfect, it may be sufficient or at least facilitate the process of achieving perfect configuration.

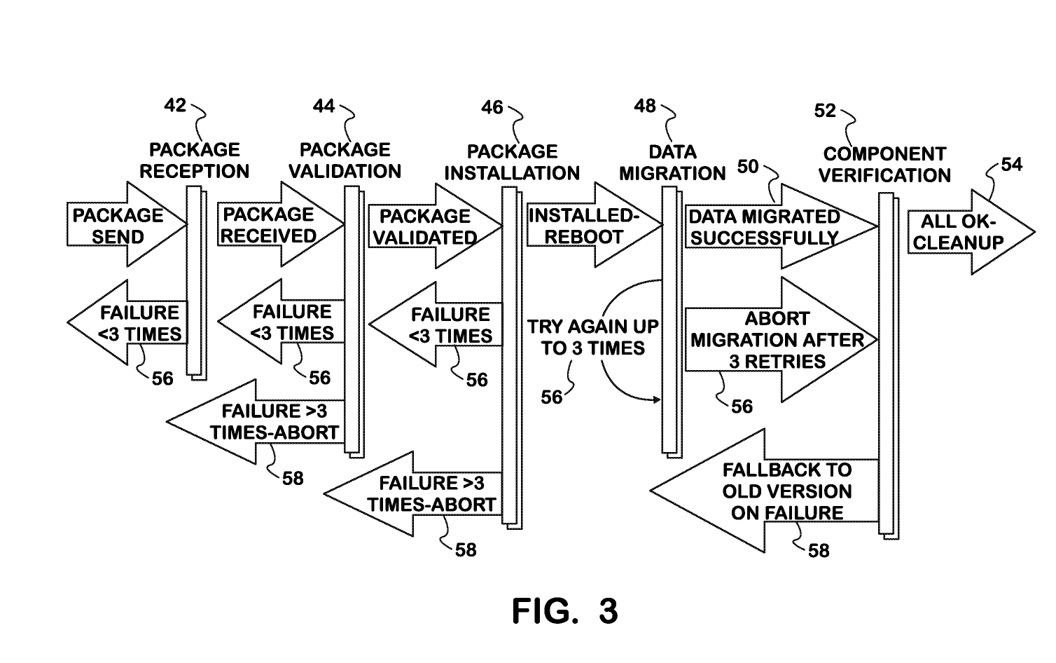

FIG. 3 shows steps in a method 40 for installing/updating software in telematic module 14. The steps comprise package reception 42, package validation 44, package installation 46, reboot 48, data migration 50, component verification 52, and clean-up 54.

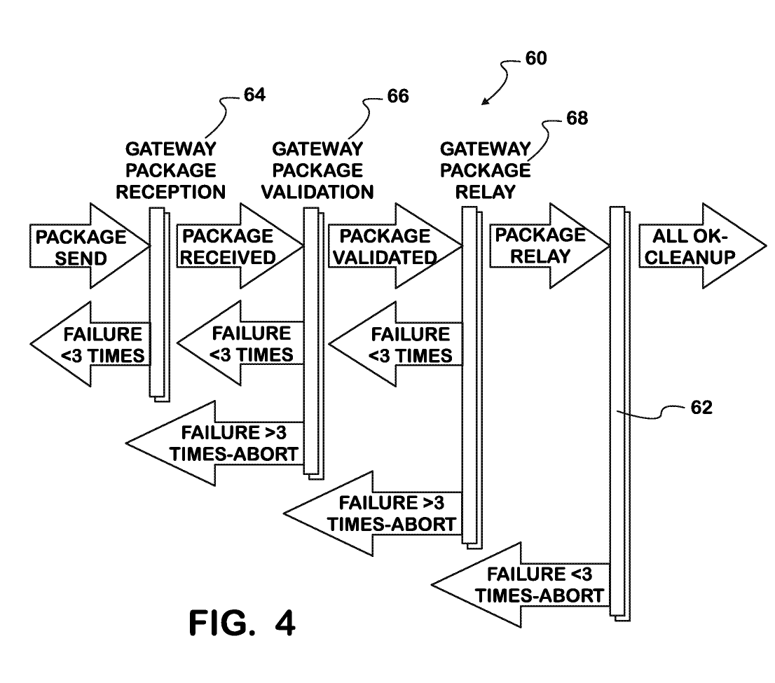

FIG. 4 shows steps in a method 60 for installing/updating software in a non-telematic module 62 via telematic module 14 serving as a gateway to the non-telematic module. The steps comprise package reception 64, package validation 66, and package relay 68 by telematic module 14. The package relay step 68 refers to delivering the package to non-telematic module 62.

In module 62, steps like those in FIG. 3 are performed. They comprise package reception, package validation, package installation, reboot, data migration, component verification, and clean-up.

When performing the steps in either module 14 or module 62, each step is verified for successful completion before the next step is allowed to proceed. Non-verification of successful completion of a step results in a limited number of repetitions of the step (reference numeral 56). After that number of repetitions without successful completion, a controlled process terminates an on-going installation or update (reference numeral 58). In the example shown a failure 56 to verify proper completion of a step causes the step to be repeated up to three times. After the third time, the entire process is aborted (58).

What is claimed is:

1. A method for installing or updating software in a motor vehicle having an electronic data system that includes a telematic module, the method comprising:
while the telematic module is operating, loading a software package into the module, then validating the package, then installing the package in the module, then stopping and re-starting the module to cause the package to become operational, causing pre-existing data and configuration information to migrate for use by the now-operational package, and operating the package with the migrated data and configuration information to verify proper operation.

2. A method as set forth in claim 1 in which execution of a succeeding step is conditioned on validation of a prior step.

3. A method as set forth in claim 2 in which a failure to verify proper completion of a step causes the step to be repeated.

4. A method as set forth in claim 3 in which failure to verify proper completion of a repeated step aborts the installing or updating process.

5. A method as set forth in claim 1 in which after the telematic module has been successfully configured or re-configured, it functions as a gateway for installing software or updating existing software in a non-telematic module in the vehicle.

6. A method as set forth in claim 5 in which with the telematic module operating as a gateway, loading a software package into the non-telematic module via the telematic module, then validating the package loaded into the non-telematic module, then installing the package in the non-telematic module, then stopping and re-starting the non-telematic module to cause the package loaded therein to become operational, causing existing data and configuration information to migrate for use by the operational package in the non-telematic module, and running the operational package in the non-telematic module with the migrated data and configuration information to verify proper operation.

7. A method as set forth in claim 6 in which execution of a succeeding step is conditioned on validation of a prior step.

8. A method as set forth in claim 7 in which a failure to verify proper completion of a step causes the step to be repeated.

9. A method as set forth in claim 8 in which failure to verify proper completion of a repeated step aborts the installing or updating process.

10. A method for installing or updating software in a motor vehicle having an electronic data system and equipment that includes a telematic module, the method comprising:
comparing certain data about the electronic system and equipment in the vehicle with corresponding data about similar vehicles already in a data base to identify software suitable for installation in the vehicle, and installing the identified software in the vehicle via the telematic module.

11. A method as set forth in claim 10 comprising while the telematic module is operating, loading a software package into the module, then validating the package, then installing the package in the module, then stopping and re-starting the module to cause the package to become operational, causing pre-existing data and configuration information to migrate for use by the now-operational package, and operating the package with the migrated data and configuration information to verify proper operation.

12. A method as set forth in claim 10 comprising using the telematic module as a gateway for installing the software package in a non-telematic module in the vehicle by loading a software package into the non-telematic module via the telematic module, then validating the package loaded into the non-telematic module, then installing the package in the non-telematic module, then stopping and re-starting the non-telematic module to cause the package loaded therein to become operational, causing existing data and configuration information to migrate for use by the operational package in the non-telematic module, and running the operational package in the non-telematic module with the migrated data and configuration information to verify proper operation.
